(19) United States
(12) Patent Application Publication
(10) Pub. No.: US 2012/0268433 A1
(43) Pub. Date: Oct. 25, 2012

(54) HEAD-MOUNTED DISPLAY

(75) Inventors: Seiji HORII, Yokohama-shi (JP); Junpei YAMAZAWA, Yokohama-shi (JP)

(73) Assignee: KYOCERA CORPORATION, Kyoto (JP)

(21) Appl. No.: 13/454,140

(22) Filed: Apr. 24, 2012

(30) Foreign Application Priority Data
Apr. 25, 2011 (JP) 2011-097511

(51) Int. Cl. G09G 5/00; G06F 3/038

(52) U.S. Cl. 345/204; 345/8

(57) ABSTRACT

According to an aspect, a head-mounted display includes a front surface portion, a first side surface portion, a second side surface portion, a display unit, a display control unit, a first component unit, and a second component unit. The first and the second side surface portions are coupled to one end and other end of the front surface portion, and have a first and a second side surface support portion at which the head-mounted display is supported, respectively. The display unit and the display control unit are arranged in the front surface portion. The first and the second component units have a heavier weight than that of the display control unit, and are arranged in a position farther from the front surface portion than the first and the second side surface support portion in the first and the second side surface portion, respectively.

### CROSS-REFERENCE TO RELATED APPLICATIONS

This application claims priority from Japanese Application No. 2011-097511, filed on Apr. 25, 2011, the content of which is incorporated by reference herein in its entirety.

### BACKGROUND

1. Technical Field

The present disclosure relates to a head-mounted display that can be worn on a head of a user and displays an image.

2. Description of the Related Art

A head-mounted display for displaying an image in a state of being worn on a head of a user has recently been available as a device for displaying an image. The head-mounted display displays an image on a screen arranged in front of eyes of the user (see Japanese Patent Application Laid-Open No. 2010-199789, Japanese Patent Application Laid-Open No. 2010-204397).

Among head-mounted displays, a helmet type is worn on the head of a user and used. However, such a device is increased in size, causing extra labor for carrying or storing thereof. Herein, a head-mounted display disclosed in Japanese Patent Application Laid-Open No. 2010-199789 or Japanese Patent Application Laid-Open No. 2010-204397 is held on a head of a user by using a nose of the user as similar to wearing a pair of glasses. Consequently, the use of the head-mounted display for a long time period causes a burden on the nose.

For the foregoing reasons, there is a need for a head-mounted display that can reduce a burden on a user at the time of use.

### SUMMARY

According to an aspect, a head-mounted display includes a front surface portion, a first side surface portion, a second side surface portion, a display unit, a signal generation unit, and a display control unit. The front surface portion has a front surface support portion at which the head-mounted display is supported. The first side surface portion is coupled to one end of the front surface portion, and has a first side surface support portion at which the head-mounted display is supported. The second side surface portion is coupled to other end of the front surface portion, and has a second side surface support portion at which the head-mounted display is supported. The display unit is arranged in the front surface portion, and displays an image. The signal generation unit is arranged in a position farther from the front surface portion than the first side surface support portion in the first side surface portion, and generates an image signal. The display control unit is arranged in the front surface portion, and controls display of the image by the display unit based on the image signal supplied from the signal generation unit.

According to another aspect, a head-mounted display includes a front surface portion, a first side surface portion, a second side surface portion, a display unit, a display control unit, a first component unit, and a second component unit. The front surface portion has a front surface support portion at which the head-mounted display is supported. The first side surface portion is coupled to one end of the front surface portion, and has a first side surface support portion at which the head-mounted display is supported. The second side surface portion is coupled to other end of the front surface portion, and has a second side surface support portion at which the head-mounted display is supported. The display unit is arranged in the front surface portion, and displays an image. The display control unit is arranged in the front surface portion, and controls display of the image by the display unit. The first component unit has a heavier weight than that of the display control unit, and is arranged in a position farther from the front surface portion than the first side surface support portion in the first side surface portion. The second component unit has a heavier weight than that of the display control unit, and is arranged in a position farther from the front surface portion than the second side surface support portion in the second side surface portion.

### BRIEF DESCRIPTION OF THE DRAWINGS

FIG. 1 is a perspective view illustrating a schematic configuration of an image display system including a head-mounted display according to an embodiment;

FIG. 2 is a diagram illustrating a state in which a user is wearing the head-mounted display illustrated in FIG. 1;

FIG. 3 is a block diagram of the image display system illustrated in FIG. 1;

FIG. 4 is a diagram illustrating loads to be applied from the head-mounted display to the user;

FIG. 5 is a diagram illustrating loads to be applied from the head-mounted display to the user;

FIG. 6 is a diagram illustrating loads to be applied from the head-mounted display to the user;

FIG. 7 is a diagram illustrating a state in which a user is wearing a head-mounted display according to another embodiment;

FIG. 8 is a diagram illustrating a state in which a user is wearing a head-mounted display according to another embodiment; and

FIG. 9 is a diagram illustrating a state in which a user is wearing a head-mounted display according to another embodiment.

### DETAILED DESCRIPTION

Exemplary embodiments of the present invention will be explained in detail below with reference to the accompanying drawings. It should be noted that the present invention is not limited by the following explanation. In addition, this disclosure encompasses not only the components specifically described in the explanation below, but also those which would be apparent to persons ordinarily skilled in the art, upon reading this disclosure, as being interchangeable with or equivalent to the specifically described components.

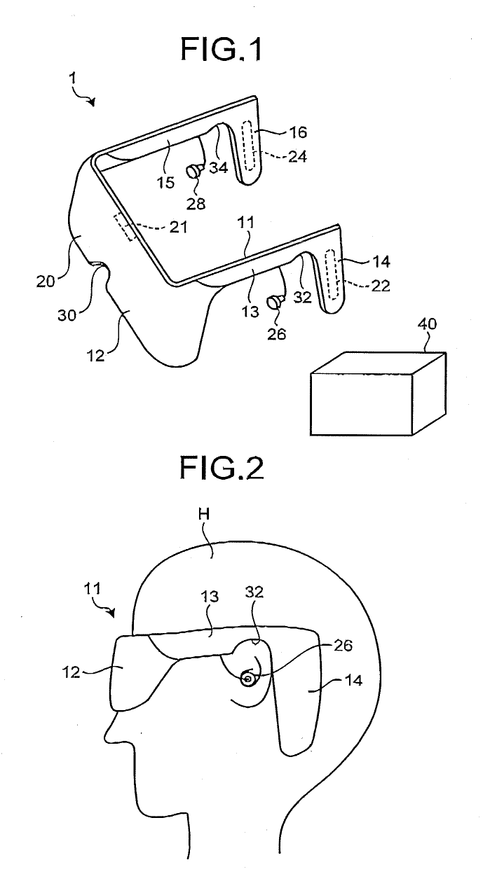

FIG. 1 is a perspective view illustrating a schematic configuration of an image display system including a head-mounted display according to an embodiment. FIG. 2 is a diagram illustrating a state in which a user is wearing the head-mounted display illustrated in FIG. 1. An image display system 1 illustrated in FIG. 1 includes a head-mounted display 11 and a control device 40. The image display system 1 allows wireless communication between the head-mounted display 11 and the control device 40, so that information of an image to be displayed on the head-mounted display 11 is supplied from the control device 40. The head-mounted display 11 processes the image information supplied from the control device 40, and displays an image, so that the image display system 1 displays the image to the user.

As illustrated in FIG. 1, the head-mounted display 11 has a shape of glasses (shape of goggles), and includes a front surface portion 12, a side surface portion 13, and a side surface portion 15. The head-mounted display 11 worn by a user H as illustrated in FIG. 2 has the front surface portion 12 arranged in front of eyes of the user H, and the side surface portions 13 and 15 arranged along respective temporal regions of the user H.

The front surface portion 12 is a portion to be arranged in front of the eyes of the user H when worn by the user H as described above. The front surface portion 12 includes a front surface support portion 30 in a middle portion of one edge portion thereof. The front surface support portion 30 contacts a nose of the user H when the head-mounted display 11 is worn by the user H. The front surface support portion 30 has a shape recessed along the nose of the user H. Since the front surface support portion 30 is supported by the nose, the front surface portion 12 is supported such that the head-mounted display 11 does not fall in a downward direction in FIG. 2 (downward direction of the head). The front surface portion 12 has a display unit 20 arranged therein. The display unit 20 displays an image on a substantially entire region thereof. Moreover, the front surface portion 12 has a display control unit 21 arranged therein. The display control unit 21 generates a signal serving as an instruction for allowing an image to be displayed on the display unit 20. The display control unit 21 of the present embodiment is arranged in an edge portion that is on an opposite side of the front surface support portion 30 in the middle portion of the front surface portion 12.

The side surface portion 13 is a portion to be arranged along a temporal region of the user H when worn by the user H as described above. One end portion of the side surface portion 13 is coupled to one end portion of the front surface portion 12. Moreover, the side surface portion 13 has a side surface support portion 32 that is formed to contact an upper side portion of an ear of the user H when worn by the user H. The side surface support portion 32 has a shape recessed along the ear of the user H. Since the side surface support portion 32 is supported by the ear, the side surface support portion 32 is supported such that the head-mounted display 11 does not fall in a downward direction in FIG. 2 (a downward direction of the head). Moreover, since the side surface support portion 32 is supported by the ear, the side surface support portion 32 is supported such that the head-mounted display 11 does not move in a horizontal direction in FIG. 2 (a front-back direction of the head).

The side surface portion 13 has a control unit 22 arranged in the other end portion 14 that is positioned farther from the front surface portion 12 than the side surface support portion 32 (portion to be supported by the ear). The end portion 14 has a shape that is bulged in a vertical direction in FIG. 2 (direction perpendicular to a direction in which the side surface portion 13 extends) relative to other portions of the side surface portion 13. Moreover, the side surface portion 13 is coupled to an earphone 26 with a wire. The earphone 26 is inserted into the ear of the user H when used as illustrated in FIG. 2.

The side surface portion 15 is a portion to be arranged along a temporal region of the user H when worn by the user H as described above. One end portion of the side surface portion 15 is coupled to the other end portion of the front surface portion 12. That is, the side surface portion 15 is arranged in a position opposite to the side surface portion 13 through the front surface portion 12. Moreover, the side surface portion 15 has a side surface support portion 34 that is formed to contact an upper side, portion of an ear of the user H when worn by the user H. The side surface support portion 34 has a shape recessed along the ear of the user. Since the side surface support portion 34 is supported by the ear, the side surface support portion 34 is supported such that the head-mounted display 11 does not fall in a downward direction of the head. Moreover, since the side surface support portion 34 is supported by the ear, the side surface support portion 34 is supported such that the head-mounted display 11 does not move in a front-back direction of the head.

Moreover, the side surface portion 15 has a power supply unit 24 arranged in the other end portion 16 that is positioned farther from the front surface portion 12 than the side surface support portion 34 (portion to be supported by the ear). The end portion 16 has a shape that is bulged in a direction perpendicular to a direction in which the side surface portion 15 extends relative to other portions of the side surface portion 15. Moreover, the side surface portion 15 is coupled to an earphone 28 with a wire. The earphone 28 is inserted into the ear of the user H when used.

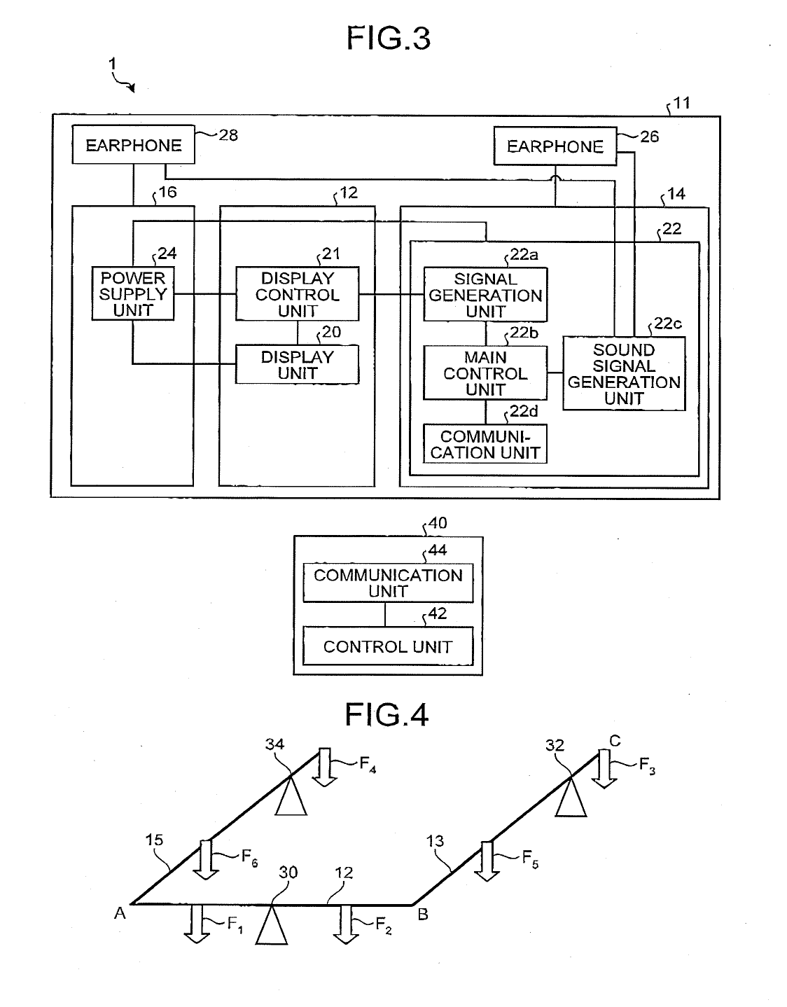

Referring to FIG. 3, functions of the image display system 1 are described. FIG. 3 is a block diagram of the image display system illustrated in FIG. 1. The image display system 1 includes the head-mounted display 11 and the control device 40 as described above. The head-mounted display 11 includes the display unit 20, the display control unit 21, the control unit 22, the power supply unit 24, and the earphones 26 and 28. The display unit 20 and the display control unit 21 are arranged in the front surface portion 12. The control unit 22 is arranged in the end portion 14, and the power supply unit 24 is arranged in the end portion 16.

The display unit 20 is a display panel for displaying video or an image thereon based on control by the display control unit 21. For example, a display panel including an LCD (liquid crystal display) or an OELD (electro-luminescence display) can be employed as the display unit 20. A display panel of the display unit 20 may be produced from a translucent or transparent plate member. When the display panel of the display unit 20 is produced from the translucent or transparent plate member, the user H can see a view outside the region covered with the display unit 20. Therefore, the user H can grasp the situations surrounding thereof even when wearing the head-mounted display 11.

The display unit 20 can employ various configurations as long as an image visually recognizable by the user H can be displayed, that is, an image can be shown to the user H. For example, the display unit 20 may have a configuration to serve as a projector for projecting an image on a display panel (screen). When an image is projected, the display unit 20 may have a configuration that allows scanning with laser light to project the image, or may have a configuration that allows transmission of light through a liquid crystal panel to project the image. The display unit 20 may have a configuration that allows an image to be displayed with respect to the user H by directly irradiating the user H with laser light therefrom.

The display control unit 21 controls operation of the display unit 20 based on image signals supplied from the control unit 22. For example, when the display unit 20 is a liquid crystal display, the display control unit 21 controls the application of voltage to Control ON and OFF switching of each liquid crystal element.

The control unit 22 includes a signal generation unit 22a, a main control unit 22b, a sound signal generation unit 22c, and a communication unit 22d. The signal generation unit 22a is a processing unit for generating a signal to be supplied to the display control unit 21. When obtaining data of an image or a moving image to be displayed on the display unit 20, the signal generation unit 22a converts the obtained data into signals that can be processed by the display control unit 21, and transmits the converted signals to the display control unit 21.

The main control unit 22b includes a processing unit such as an MPU (micro processing unit), and executes various processes of the head-mounted display 11 described above according to the procedure instructed by software. That is, the main control unit 22b executes a process by sequentially reading command codes from an operating system program or an application program, for example. Accordingly, the main control unit 22b controls operation of each unit, and transmits necessary data to each unit. For example, the main control unit 22b transmits data of an image to the signal generation unit 22a, and transmits a sound signal to the sound signal generation unit 22c.

The control unit 22 includes a storage unit for storing these various programs. For example, the storage unit includes a non-volatile storage device (e.g., non-volatile semi-conductor memory of ROM (read only memory), and a hard disk device), or a readable and writable storage device (e.g., SRAM (static random access memory), and DRAM (dynamic random access memory)).

The sound signal generation unit 22c executes a process on sound signals to be output from the earphones 26 and 28. That is, the sound signal generation unit 22c performs processes such as decoding, DA (digital to analog) conversion, and amplification on sound data transmitted from the main control unit 22b to convert the sound data into analog sound signals, and then outputs the analog sound signals to the earphones 26 and 28.

The communication unit 22d communicates wirelessly with a communication unit 44 of the control device 40. The communication unit 44 will be described later. The communication unit 22d transmits and receives various information by communication with the control device 40. The communication unit 22d may be communicable with a communication terminal other than the control device 40. The communication unit 22d, for example, may establish a wireless signal path using a CDMA (code division multiple access) system, or any other wireless communication protocols, with a base station via a channel allocated by the base station, and performs telephone communication and information communication with the base station. Any other wired or wireless communication or network interfaces, e.g., LAN, Bluetooth, Wi-Fi, NFC (Near Field Communication) may also be included in lieu of or in addition to the communication unit 22d.

The power supply unit 24 is a supply source for supplying electric power, and supplies electric power to each of the functional units of the head-mounted display 11 including the control unit 22. The power supply unit 24 can also employ a chargeable battery or an exchangeable and disposable dry cell as a supply source.

The earphones 26 and 28 are sound output units for outputting sound based on analog sound signals supplied from the sound signal generation unit 22c.

The control device 40 includes a control unit 42 and the communication unit 44. The control unit 42 includes a processing unit such as an MPU, and executes various processes according to the procedure instructed by software. That is, the control unit 42 executes a process by sequentially reading command codes from an operating system program or an application program, for example. Accordingly, the control unit 42 controls operation of each unit, and transmits necessary data to each unit. For example, the control unit 42 transmits various information to be transmitted to the head-mounted display 11, such as data of a video, data of a moving image, and information of various control instruction, to the communication unit 44.

The communication unit 44 communicates wirelessly with the communication unit 22d of the head-mounted display 11. The communication unit 44 transmits and receives various information by communication with the head-mounted display 11. The communication unit 44 may be communicable with a communication terminal other than the head-mounted display 11 as similar to the communication unit 22d.

The image display system 1 and the head-mounted display 11 may have various configurations that are normally employed in image display systems and head-mounted displays in addition to the above described configurations. The image display system 1 and the head-mounted display 11, for example, may have an operation unit for inputting operation by the user H. The operation unit may be provided in the head-mounted display 11 or provided as another body. When the operation unit is provided as another body, operation may be input through communication with the communication unit 22d and the communication unit 44.

The image display system 1 allows transmission of video data and the like to be displayed on the head-mounted display 11 from the control device 40, and allows the head-mounted display 11 to process the data, so that an image and sound can be provided to the user H wearing the head-mounted display 11. That is, an image can be shown to and sound can be heard by the user H. When the head-mounted display 11 obtains video data and the like by communication between the communication unit 22d and the communication unit 44 of the control device 40, the main control unit 22b processes the data, and transmits data of an image to the signal generation unit 22a and data of sound to the sound signal generation unit 22c. The signal generation unit 22a generates signals that can be processed by the display control unit 21 based on the image data transmitted from the main control unit 22b, and transmits the generated signals to the display control unit 21. The display control unit 21 controls the operation of the display unit 20 based on the signals, so that an image of the image data is displayed to the user H by the display unit 20. The sound signal generation unit 22c processes the data of sound, and transmits generated signals to the earphones 26 and 28. The earphones 26 and 28 output sound based on the supplied signals. Accordingly, the sound is output to the user H.

The image display system 1 and the head-mounted display 11 according to the present embodiment can reduce a burden on the user H at the time of use by arrangement of the control unit 22 in the end portion 14 and arrangement of the power supply unit 24 in the end portion 16.

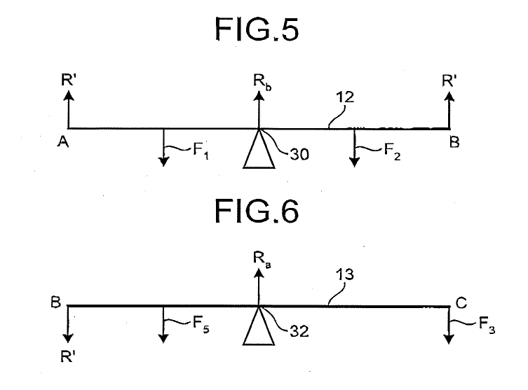

Hereafter, a description is given with reference to FIGS. 4 to 6. Each of FIGS. 4 to 6 is a diagram illustrating loads to be applied to the user H from the head-mounted display. FIGS. 4 to 6 illustrate loads to be applied to the front surface support portion 30 and the side surface support portions 32 and 34 in a case where the front surface portion 12 and the side surface portions 13 and 15 of the head-mounted display 11 are approximated to a beam (assumed to be horizontal members connected to each other such that loads are applied to points at the same height by the members). As illustrated in FIGS. 4 and 5, the load of the front surface portion 12 of the head-mounted display 11 is assumed to be applied as a force F₁ and a force F₂. The force F₁ is applied to the center of gravity of a region from a coupling portion A between the front surface portion 12 and the side surface portion 15 to the front surface support portion 30. The force F₂ is applied to the center of gravity of a region from a coupling portion B between the front surface portion 12 and the side surface portion 13 to the front surface support portion 30. Herein, a force to be applied to each of the coupling potion A and the coupling potion B is R′, and a force to be applied to the front surface support portion 30 is R_{b}.

As illustrated in FIGS. 4 and 6, the load of the side surface portion 13 is assumed to be applied as F₂ that is a load of the end portion 14 (control unit 22), and a force F₅ to be applied to the center of gravity of a region from the coupling potion B to the side surface support portion 32 (a region of the side surface portion 13 excluding the end portion 14). As illustrated in FIG. 4, moreover, the load of the side surface portion 15 is assumed to be applied as F₄ that is a load of the end portion 16, and a force F₆ to be applied to the center of gravity of a region from the coupling potion A to the side surface support portion 34 (a region of the side surface portion 15 excluding the end portion 16). Herein, a force to be applied to the side surface support portion 32 is Rₐ.

For example, where a load (weight) of the front surface portion 12 is 100 g, where each load of the regions in the side surface portions 13 and 15 excluding respective end portions thereof is 10 g, and where each load of the end portions 14 and 16 is 40 g, the force R_{b} to be applied to the front surface support portion 30 is 62 g. On the other hand, in a configuration in which the control unit 22 and the power supply unit 24 are arranged in the front surface portion 12, that is, in a configuration in which 80 g is arranged in the front surface portion 12 instead of the end portions 14 and 16, the force R_{b} to be applied to the front surface support portion 30 is 75 g. According to a configuration of the present embodiment, therefore, a burden to be applied on the front surface support portion 30, that is, a burden to be applied on a nose, can be reduced by approximately 20%.

Accordingly, the control unit 22 and the power supply unit 24 having a relatively heavy weight are arranged in the end portions 14 and 16, that is, in positions farther from the front surface portion 12 than portions of the side surface portions 13 and 15 supported by the ears, so that the center of gravity of the head-mounted display 11 can be in a position further back and away from the front surface portion 12. Consequently, a burden to be applied on the nose of the user H at the time of use can be reduced.

Moreover, only the display control unit 21 for controlling the display unit 20 is arranged in the front surface portion 12, and the signal generation unit 22a as a control circuit for generating a signal of image data and the like is arranged in the end portion 14, so that the head-mounted display 11 can further reduce a weight of the front surface portion 12 by reduction of the number of control circuits to be arranged in the front surface portion 12. If a relationship between the display control unit 21 and the signal generation unit 22a is compared to, for example, a relationship between functions arranged in housing s of a folding mobile phone, a function arranged in a housing in which a display unit is arranged corresponds to the display control unit 21, whereas a function arranged in the housing in which the display unit is not arranged corresponds to the signal generation unit 22a.

Moreover, the power supply unit 24 is provided, 50 that each of the necessary units for a goggle shape can be provided, and thus the head-mounted display 11 can be easily carried. The head-mounted display 11 includes the power supply unit 24 installed thereinside, and performs wireless communication by the communication unit 22d, so that the wiring extending from a head of the user H to other portions is not necessarily provided, thereby suppressing a nuisance of the wiring at the time of use.

The head-mounted display 11 is provided with the power supply unit 24, out of two end portions 14 and 16, in the end portion 16 where the control unit 22 is not arranged. However, the arrangement of the power supply unit 24 is not limited thereto. The power supply unit 24 may be arranged in both of the end portions 14 and 16. Moreover, the head-mounted display 11 may allow a portion of the control unit 22 to be arranged in the end portion 16. The head-mounted display 11 preferably allow the control unit 22 and the power supply unit 24 to be arranged such that weights of the end portions 14 and 16 are equal. The equality of the weights can reduce a burden on the user H at the time of use.

The head-mounted display 11 has the control unit 22 and the power supply unit 24 arranged in the two end portions 14 and 16, thereby reducing a burden on the nose at a greater rate. However, the arrangement of the control unit 22 and the power supply unit 24 is not limited thereto. The head-mounted display 11 may allow the control unit 22 and the power supply unit 24 to be arranged in positions farther from the front surface portion 12 than the side surface support portions 32 and 34 (portions to be supported by the ears). The head-mounted display 11 may allow at least the signal generation unit 22a to be arranged in a position farther from the front surface portion 12 than the side surface support portion 32 (portion to be supported by the ear). Since the signal generation unit 22a can be arranged in a position farther from the front surface portion 12 than side surface support portion 32, the head-mounted display 11 can allow a portion of the circuit necessary for driving the display unit 20 to be arranged in a position other than the front surface portion 12, the position being in which a burden on the nose can be reduced. Therefore, the head-mounted display 11 can reduce a burden on the user H at the time.

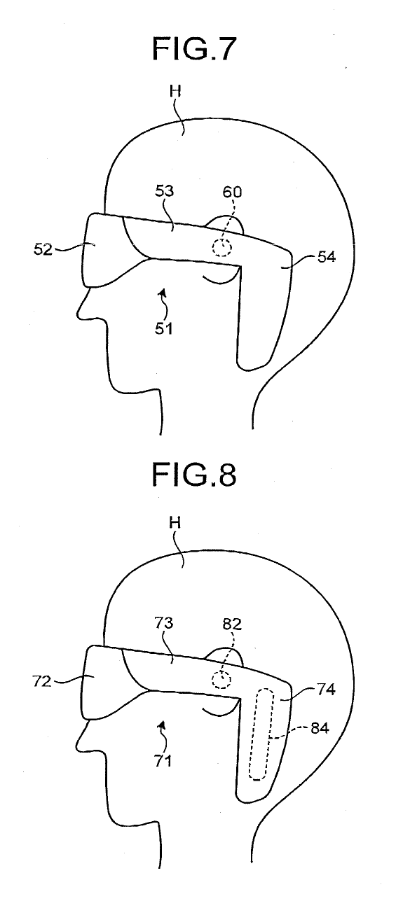

The head-mounted display 11 of the above embodiment is provided with the side surface support portions 32 and 34 to be placed over the ears as portions to be supported by the ears. However, a configuration of the portions to be supported by the ears is not limited thereto. FIG. 7 is a diagram illustrating a state in which the user H is wearing a head-mounted display according to another embodiment. A head-mounted display 51 illustrated in FIG. 7 has a shape of goggles, and includes a front surface portion 52 and a side surface portion 53 coupled to one end portion of the front surface portion 52. The head-mounted display 51 also includes a side surface portion to be coupled to the other end portion of the front surface portion 52 in a position opposite to the side surface portion 53 although the portion is omitted in FIG. 7. The side surface portion 53 has an end portion 54 on a side thereof that is not coupled to the front surface portion 52, and the end portion 54 has a larger shape than other portions as similar to the end portion 14 described above. The end portion 54 includes a control unit and the like arranged inside thereof.

The side surface portion 53 is coupled to the front surface portion 52, and has an earphone 60 fixed in a portion (bar shaped portion) extending along a temporal region of the user H. The earphone 60 is a mechanism to be inserted into a cavity of the ear of the user H. The earphone 60 to be inserted into the cavity of the ear of the user H is fixed to the side surface portion 53, that is, the head-mounted display 11 allows the earphone 60 to serve as a portion to be supported by the ear, that is, a side surface support portion. The side surface portion positioned opposite to the side surface portion 53 has a similar structure. Since the earphone 60 is allowed to serve as the side surface support portion, the head-mounted display 51 can allow a member that is to be inserted into the cavity of the ear and contacts the user H with a surface thereof to serve as the side surface support portion. Consequently, the head-mounted display 51 can reduce a burden to be applied on the user H at the time of use. Moreover, the use of the earphone 60 as the side surface support portion can further simplify an apparatus configuration.

In the above embodiment, the earphone is used as a sound output unit. However, the sound output unit is not limited thereto. FIG. 8 is a diagram illustrating a state in which the user H is wearing a head-mounted display according to another embodiment. A head-mounted display 71 illustrated in FIG. 8 has a shape of goggles, and includes a front surface portion 72 and a side surface portion 73 coupled to one end portion of the front surface portion 72. The head-mounted display 71 also includes a side surface portion to be coupled to the other end portion of the front surface portion 72 in a position opposite to the side surface portion 73 although the portion is omitted in FIG. 8. The side surface portion 73 has an end portion 74 on a side thereof that is not coupled to the front surface portion 72, and the end portion 74 has a larger shape than other portions as similar to the end portion 14 described above. The end portion 74 has a control unit and the like arranged inside thereof.

The side surface portion 73 is coupled to the front surface portion 72, and has a side surface support portion 82 fixed in a portion (bar shaped portion) extending along a temporal region of the user H. The side surface support portion 82 is a mechanism to be inserted into a cavity of the ear of the user H. That is, the side surface support portion 82 is a protrusion portion without a sound output function. The head-mounted display 71 allows the side surface support portion 82 which is fixed in the side surface portion 73 and is to be inserted into the cavity of the ear of the user H to serve as a portion to be supported by the ear, that is, a side surface support portion. The side surface portion positioned opposite to the side surface portion 73 has a similar structure. Since the side surface support portion 82 is provided, the head-mounted display 71 can allow a member that is to be inserted into the cavity of the ear and contacts the user H with a surface thereof to serve as the side surface support portion. Consequently, the head-mounted display 71 can further reduce a burden to be applied on the user H at the time of use.

The head-mounted display 71 has a sound output unit 84 arranged in the end portion 74. The sound output unit 84 is a mechanism for outputting sound to the user H using bone conduction. The sound output unit 84 is arranged in a region that contacts the user H at the time of wearing, the region being within the end portion 74. Accordingly, since the head-mounted display 71 is used in contact with the user H, a mechanism for outputting sound to the user H using the bone conduction can be employed. Moreover, the sound output unit 84 is arranged in the end portion 74, so that the head-mounted display 71 can further increase a ratio of weight of the end portion 74. Therefore, a burden to be applied on the nose of the user H can be further reduced.

A head-mounted display can be provided with both of a mechanism to be inserted into the cavity of the ear as illustrated in FIGS. 7 and 8 and a mechanism to be placed over the ear as illustrated in FIG. 2 as side surface support portions.

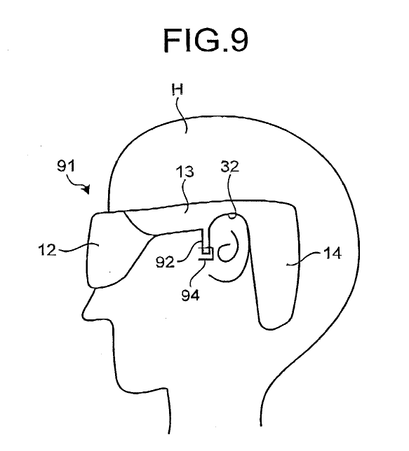

FIG. 9 is a diagram illustrating a state in which the user H is wearing a head-mounted display according to another embodiment. As illustrated in FIG. 9, a head-mounted display 91 is basically similar to the head-mounted display 11 except for a configuration of a sound output unit. The head-mounted display 91 has a shape of goggles, and includes a front surface portion 12 and a side surface portion 13 coupled to one end portion of the front surface portion 12. The head-mounted display 91 also includes a side surface portion to be coupled to the other end portion of the front surface portion 12 in a position opposite to the side surface portion 13 although the portion is omitted in FIG. 9. The side surface portion 13 has an end portion 14 on a side thereof that is not coupled to the front surface portion 12, and the end portion 14 includes a control unit and the like installed inside thereof.

The head-mounted display 91 includes a sound output unit 92 coupled to the side surface portion 13. The sound output unit 92 is a mechanism for outputting sound to the user H using bone conduction, and is arranged in a region that contacts a cartilage (a protruding portion antezior to the ear and near the eye) of the user H at the time of wearing, the region being within the side surface portion 13. Accordingly, since the bead-mounted display 91 is used in contact with the user H, a mechanism for outputting sound to the user H using the bone conduction can be employed. Moreover, the head-mounted display 91 can suitably transmit sound by transmission of the sound to the cartilage of the user H by the sound output unit 92. Moreover, the side surface portion 13 is supported by the side surface support portion 32, and the sound is transmitted by the sound output unit 92, so that the head-mounted display 91 can transmit the sound in a state of being supported by the ear without blocking the cavity of the ear. Therefore, the user H can use the head-mounted display 91 in a state of hearing outside sound.

The advantages are that one embodiment of the invention provides a head-mounted display that can reduce a burden on a user at the time of use.

What is claimed is:

1. A head-mounted display comprising:
a front surface portion having a front surface support portion at which the head-mounted display is supported;
a first side surface portion coupled to one end of the front surface portion and having a first side surface support portion at which the head-mounted display is supported;
a second side surface portion coupled to other end of the front surface portion and having a second side surface support portion at which the head-mounted display is supported;
a display unit arranged in the front surface portion for displaying an image;
a signal generation unit arranged in a position farther from the front surface portion than the first side surface support portion in the first side surface portion for generating an image signal; and
a display control unit arranged in the front surface portion for controlling display of the image by the display unit based on the image signal supplied from the signal generation unit.

2. The head-mounted display according to claim 1, further comprising
a battery arranged in a position farther from the front surface portion than the second side surface support portion in the second side surface portion for supplying electric power to the display unit.

3. The head-mounted display according to claim 1, wherein the display unit is configured to display the image on a screen arranged in the front surface portion.

4. The head-mounted display according to claim 1, wherein the front surface portion is formed of a translucent or transparent member.

5. The head-mounted display according to claim 1, wherein
the first side surface portion includes a first protrusion portion to be inserted into one ear of a user, and
the second side surface portion includes a second protrusion portion to be inserted into other ear of the user.

6. The head-mounted display according to claim 5, further comprising a sound signal generation unit for generating a sound signal, wherein
the first protrusion portion and the second protrusion portion are earphones for outputting sound based on the sound signal, and
the sound signal generation unit is arranged in a position farther from the front surface portion than the first side surface support portion in the first side surface portion, or in a position farther from the front surface portion than the second side surface support portion in the second side surface portion.

7. The head-mounted display according to claim 1, further comprising:
a sound output unit arranged in at least one of the first side surface portion and the first side surface portion for outputting sound using the bone conduction; and
a sound signal generation unit which is arranged in a position farther from the front surface portion than the first side surface support portion in the first side surface portion, or in a position farther from the front surface portion than the second side surface support portion in the second side surface portion, for generating a sound signal to be output by the sound output unit.

8. A head-mounted display comprising:
a front surface portion having a front surface support portion at which the head-mounted display is supported;
a first side surface portion coupled to one end of the front surface portion and having a first side surface support portion at which the head-mounted display is supported;
a second side surface portion coupled to other end of the front surface portion and having a second side surface support portion at which the head-mounted display is supported;
a display unit arranged in the front surface portion for displaying an image;
a display control unit arranged in the front surface portion for controlling display of the image by the display unit;
a first component unit having a heavier weight than that of the display control unit and arranged in a position farther from the front surface portion than the first side surface support portion in the first side surface portion; and
a second component unit having a heavier weight than that of the display control unit and arranged in a position farther from the front surface portion than the second side surface support portion in the second side surface portion.
